(19) United States
(12) Patent Application Publication
(10) Pub. No.: US 2024/0352602 A1
(43) Pub. Date: Oct. 24, 2024

(54) A CATALYST

(71) Applicant: NewSouth Innovations Pty Limited, New South Wales (AU)

(72) Inventors: Chuan ZHAO, Sydney (AU); Wenhao REN, Sydney (AU); Qian SUN, Sydney (AU)

(21) Appl. No.: 18/687,648

(22) PCT Filed: Aug. 31, 2022
(86) PCT No.: PCT/AU2022/051063

§ 371 Date: May 14, 2024

(30) Foreign Application Priority Data
Aug. 31, 2021 (AU) 2021902818

(51) Int. Cl. C25B 11/075; C25B 1/23; C25B 11/037; C25B 11/065

(52) U.S. Cl. CPC C25B 11/075; C25B 1/23; C25B 11/037; C25B 11/065

(57) ABSTRACT

The present invention provides a catalyst comprising: a conductive carbon substrate comprising nitrogen; a transition metal nanoparticle enveloped within the conductive carbon substrate; and a single atom transition metal catalytic site located on a surface of the conductive carbon substrate, wherein the transition metal nanoparticle and the single atom transition metal catalytic site are arranged so that there is electrical communication between the single atom transition metal catalytic site and the transition metal nanoparticle. A method of producing a catalyst of the invention is also provided, and used as an electrolysis catalyst. Further, an electrolyser for producing carbon monoxide (CO) from carbon dioxide (CO2) using the catalyst of the invention is provided.

### FIELD

The present invention relates to the field of catalysts. In particular, the present invention is directed to a transition metal catalyst for the selective conversion of carbon dioxide to carbon monoxide. However, it will be appreciated that the invention is not limited to this particular field of use.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

The electrochemical CO₂ reduction reaction (CO₂RR) is emerging as a sustainable carbon-neutral approach to recycle carbon dioxide (CO₂), store intermittent renewable energy and produce reactive precursor compounds for chemical synthesis. However, CO₂ is chemically inert, and can form up to 16 different products via electrolysis, meaning that a selective catalyst is required to specifically convert CO₂ into carbon monoxide (CO). Additionally, in order to be industrially applicable, electrolysers must be capable of achieving high selectivity at high current (>200 mA cm⁻²) and at low overpotentials.

Catalysts which use precious metals such as gold, silver and platinum are generally preferred CO₂RR catalysts, however the use of such metals can be prohibitive at the industrial scale. More recently, single-atom catalysts have shown promise as CO₂RR catalysts. In such catalysts, single atoms of more cost-effective transition metals, such as nickel, cobalt and iron, are bound to a conductive carbon substrate that is doped with nitrogen, forming metal-N—C structures that have shown to be highly selective for converting CO₂ to CO, as opposed to nanoparticles of the same metals which preferentially catalyse the hydrogen evolution reaction (HER; producing H₂ gas from an acidic solution). However, such catalysts usually have a very low metal loading, which limits the practical activity of the catalyst and the operating current of the electrolyser. Additionally, the pursuit of “pure” single atom catalysts (i.e., with even distribution of single atom catalyst sites, and without aggregations of metal atoms, or the formation of nanoparticles) requires sophisticated synthesis controls with low productivity, limiting the industrial applicability of such catalysts. Accordingly, there is a need for a catalyst that has at least one of the features of: is industrially applicable; has good selectivity for CO₂RR over HER; is operable and stable at an industrially relevant current; and which is able to be produced simply and economically.

It is an object of the present invention that at least one of the needs above is at least partially satisfied.

It is an object of the present invention to overcome or ameliorate one or more the disadvantages of the prior art, or at least to provide a useful alternative.

### SUMMARY OF INVENTION

In a first aspect of the present invention, there is provided a catalyst comprising:
a conductive carbon substrate comprising nitrogen;
a transition metal nanoparticle enveloped within the conductive carbon substrate; and
a single atom transition metal catalytic site located on a surface of the conductive carbon substrate,
wherein the transition metal nanoparticle and the single atom transition metal catalytic site are arranged so that there is electrical communication between the single atom transition metal catalytic site and the transition metal nanoparticle.

The following options may be used in conjunction with the first aspect either individually or in any suitable combination.

The transition metal nanoparticles and the transition metal single atom catalytic sites may comprise any suitable transition metal. For example, the transition metal may comprise cobalt, iron, nickel, copper, zinc, chromium, manganese, yttrium, scandium, tin, bismuth, and molybdenum or any combination thereof. In some embodiments, the precious metals (i.e., gold, silver, platinum and palladium) may be avoided. The transition metal nanoparticles may comprise the same transition metal as the transition metal single atom catalytic sites, or they may comprise different transition metals. The transition metal may be preferably selected from the group consisting of cobalt, nickel and iron. The transition metal may be nickel.

The nitrogen-doped conductive carbon substrate may take any suitable form. The substrate may comprise carbon nanotubes, graphite sheets, buckyballs or any suitable combination thereof. The substrate may be entirely, or substantially, in the form of nitrogen-doped carbon nanotubes (single-walled, or multi-walled). The substrate must be capable of at least partially, and preferably completely enveloping the transition metal nanoparticle. The nanoparticle may be less than 50 nm in size, or between about 10 nm and about 30 nm so as to be located within a carbon nanotube. In some embodiments, when two or more transition metal nanoparticles are present, the average diameter of the nanoparticles may be less than about 50 nm, or between about 10 nm and 30 nm.

The catalyst may be an electrocatalyst, whereby the catalyst is used as an electrode in conjunction with an electrical current. The catalyst may be used as a cathode or it may used as an anode. The catalyst may be used as the cathode in carbon dioxide electrocatalysis, whereby CO₂ is converted to CO.

In a second aspect of the present invention, there is provided a method of producing a catalyst comprising a conductive carbon substrate doped with nitrogen, a transition metal nanoparticle enveloped within the conductive carbon substrate, and a single atom transition metal catalytic site, said method comprising the following steps:
heating a mixture to a temperature between about 800° C. and about 1100° C., the mixture comprising:
   a transition metal salt; and
   a compound comprising carbon and nitrogen,
under such conditions to thereby produce the catalyst.

The following options may be used in conjunction with the first or second aspects either individually or in any suitable combination.

The transition metal salt may comprise any suitable salt. In preferred embodiments, it may comprise cobalt, nickel, iron or it may comprise a combination thereof. The transition metal salt may comprise nickel and may be selected from the group consisting of Ni(NO₃)₂, NiSO₄ and NiCl₂. It may be Ni(NO₃)₂. When heated in the method of the second aspect, the transition metal salt decomposes and forms the nanoparticles and the single atom catalytic sites.

The compound comprising carbon and nitrogen may be any suitable compound comprising, or consisting of, carbon, nitrogen and hydrogen. It may be comprising carbon and nitrogen. It may be melamine.

The temperature reached in the method may be about 1000° C. The conditions used in the method may comprise heating the mixture with an inert gas. The inert gas may be selected from neon, argon, nitrogen or a mixture thereof.

In a third aspect of the present invention, there is provided a catalyst produced by the method of the second aspect.

In a fourth aspect of the present invention, there is provided the use of a catalyst according to the first aspect or the second aspect as an electrolysis catalyst. In preferred embodiments, the electrolysis catalyst converts carbon dioxide into carbon monoxide.

In a fifth aspect of the present invention, there is provided an electrolyser for producing carbon monoxide (CO) from carbon dioxide (CO₂), the electrolyser comprising a cathode which comprises a catalyst according to the first or third aspects.

In a sixth aspect of the present invention, there is provided a method of synthesising carbon monoxide (CO) comprising providing carbon dioxide (CO₂) to an electrolyser according to the fifth aspect, wherein a voltage of between −0.2 V and −2.5 V is applied to the electrolyser to thereby provide said carbon monoxide (CO).

As disclosed herein, it will be appreciated that the catalyst of the invention is adapted or configured to achieve current density of at least 100, 110, 120, or 130 mA cm⁻². It will be further appreciated that the transition metal nanoparticle is spatially oriented into electrical communication with the single atom transition metal catalytic site, which are on opposite sides of the conductive carbon substrate, and that the transition metal nanoparticle is preferably contained within a carbon nanotube.

### BRIEF DESCRIPTION OF DRAWINGS

Embodiments of the present invention will now be described, by way of example only, with reference to the accompanying figures, wherein:

FIG. 1: The calculated free energy diagrams for CO₂RR to CO on neutral and negatively charged Ni—N₄—C (a) and Ni—N₃V-C (b) structures.

FIG. 2: The number of electrons on Ni single atom in neutral and negatively charged Ni—N—C structures (a) and the difference in limiting potentials for CO₂ reduction and H₂ evolution on neutral and negatively charged Ni—N composite catalysts (b).

FIG. 3: Transmission electron microscopy (TEM) image of NiSA/NP (a) and NiSA (b), respectively. (c) High-angle annular dark-field scanning transmission electron microscopy (HAADF-STEM) image of NiSA/NP. (d) Ni K-edge X-ray absorption (XAS) spectra of NiSA/NP and NiSA with the comparison of standard NiPc and Ni foil. (e) The corresponding plotted Fourier transformation of extended X-ray absorption fine structure (FT-EXAFS) spectra. (f) The first shell (Ni—N) fitting of FT-EXAFS spectra for NiSA.

FIG. 4: X-ray diffraction patterns (a) and photoelectron spectroscopy (XPS) analysis (b-d). (a) X-ray diffraction scattering patterns for both NiSA/NP and NiSA, combined to the expected scattering angles of graphite and Ni; (b) Ni 2p spectra of NiSA, NiSA/NP and NiPc; N 1s spectra of NiSA/NP (c), and NiSA (d).

FIG. 5: Partial CO currents plotted against different potentials for NiSA/NP and NiSA (a) and stability testing at −0.75 V vs. RHE for 30 h electrolysis for NiSA/NP (b).

FIG. 6: (a) j_{CO} and FE_{CO} at different potentials in 1 M KOH microfluidic cells. (b) Polarisation curves obtained at a scan rate of 10 mV s⁻¹ in the zero-gap MEA full cells with IrO₂ and NiFe as the anode, and 1 M KOH as the anode electrolyte. (c) j_{CO} and FE_{CO} as a function of overall NiSA/NP∥NiFe cell voltages from −1.8 V to −2.3 V. (d) Comparison of the state-of-the-art Au, Ag, Ni—N—C and CoPc catalysts in full cell performance.

### DEFINITIONS

The following definitions are provided to enable the skilled person to better understand the invention disclosed herein. These are intended to be general and are not intended to limit the scope of the invention to these terms or definitions alone. Unless defined otherwise, all technical and scientific terms used herein have the same meaning as commonly understood by one having ordinary skill in the art to which the invention pertains.

As used herein “electrocatalyst” refers to a kind of catalyst that participates in electrochemical reactions. As “electrocatalyst” usually functions at an electrode surface, or as the electrode surface itself.

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising” do not imply that the specified integer(s) represent a major part of the whole.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of.” In other words, with respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The terms “predominantly” and “substantially” as used herein shall mean comprising more than 50% by weight, unless otherwise indicated.

As used herein, with reference to numbers in a range of numerals, the terms “about,” “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, wt. % refers to the weight of a particular component relative to total weight of the referenced composition.

The complete disclosures of the patents, patent documents and publications cited herein are incorporated by reference in their entirety as if each were individually incorporated.

### DESCRIPTION OF EMBODIMENTS

The following description conveys exemplary embodiments of the present invention in sufficient detail to enable those of ordinary skill in the art to practice the present invention. Features or limitations of the various embodiments described do not necessarily limit other embodiments of the present invention or the present invention as a whole. Hence, the following detailed description does not limit the scope of the present invention, which is defined only by the claims.

The present invention relates to a catalyst for selectively producing carbon monoxide (CO) from carbon dioxide (CO₂) (i.e., a carbon dioxide electrolysis catalyst, or electrocatalyst), as well as a method for producing the catalyst and an apparatus which uses the catalyst.

In particular, the inventors have developed a catalyst that uses transition metals (such as cobalt, nickel and iron), instead of precious metals (such as gold, silver and platinum) to produce a catalyst that is an improvement over similar known catalysts, in terms of at least one of robustness, ease of production, volume of product output and industrial-scale operating conditions. Advantageously, as will be described below in more detail and with reference to the examples, the catalyst of the present invention combines nanoparticles and single-atom catalyst sites, yet maintains selectivity for the CO₂RR (i.e., reduction of CO₂ to CO) over the competing HER (i.e., the production of hydrogen gas).

### Electrolysis

As the skilled person would be aware, electrolysis is a process whereby electricity is used to propagate a non-spontaneous reaction. Generally, electrons are provided to the cathode which provides sufficient energy to overcome an activation barrier that would otherwise preclude the chemical reaction occurring. Such an example is the reduction of CO₂, which is an otherwise stable, relatively inert compound due to strong carbon-oxygen double bonds.

The electrolysis of CO₂ to CO is understood to require three steps:

CO₂+*+(H⁺+e⁻)→COOH* (1)

COOH*+(H⁺+e⁻)→CO*+H₂O (2)

CO*→CO+* (3)

As may be expected, the conversion of CO₂ to COOH* (a carboxyl radical) in step 1 is the rate limiting step which has the greatest activation barrier, and so requires the most amount of energy in order to react. One approach to lowering this activation barrier is to use a catalyst in conjunction with the cathode, whereby the catalyst binds to the reactant and reduces the energy required for the reaction to occur. Such catalysts may also be referred to as electrocatalysts and the process may be referred to as electrocatalysis.

During the electrocatalysis of CO₂, it is understood that the CO₂ adsorbs onto the surface of a transition metal catalytic surface, which lowers the activation energy so that it is reduced to COOH* at a relatively low voltage bias. However, a dominant side reaction that can also occur at the cathode of an electrolytic cell and compete with the CO₂RR is the hydrogen evolution reaction (HER), whereby hydrogen is produced according to the reaction:

2H⁺+2e⁻→H₂

### Catalyst

In order to select the CO₂RR over the HER, a catalytic surface is required that lowers the activation barrier of the first step of the CO₂RR so that it is lower than the energy required to generate hydrogen.

It has been recently understood in the art that single atoms of a transition metal, when bound to a substrate surface or alloyed with other metals, display catalytic properties that are distinct from the same element in a bulk form, such as providing enhanced selectivity and/or activity, due to an unsaturated valence electron configuration that is found in the single atoms. For example, it is known in the art that catalyst sites consisting of single atoms of nickel have a deficient valence shell, with a valence of about Ni⁺, or between Ni⁺ and Ni²⁺. Although Ni—N—C sites typically show very weak binding of the CO₂ and COOH* species, the combination of an electron rich Ni atom (which may be enhanced by the presence of a vacancy in the coordination sphere of the Ni atom) with an overall valence deficiency is thought to mean that the single-atom nickel more readily adsorbs electron-rich species such as CO₂ and COOH* and hence selectively drives the CO₂RR process. In contrast, the surface nickel in a bulk form, such as foil, a nanoparticle or a solid nickel electrode, is more likely to have a complete valence shell arrangement (i.e., Ni⁰) and therefore be less selective. Indeed, bulk nickel, such as in a nanoparticle or a solid electrode, tends to also generate hydrogen gas via the HER, rather than favour the CO₂RR (as well as producing other side products via competing reactions), which leads to a gaseous product stream comprising both CO and H₂ (amongst other impurities), which may be then difficult to separate.

Accordingly, it is preferable that a catalyst, or more specifically a selective CO₂RR electrocatalyst, of the present invention, only has single-atom transition metal sites that are accessible on the surface of the catalyst. Further, it is understood by the inventors that the advantageous features of the catalyst of the present invention are surprisingly provided by electronic interactions, or electronic communication, between the transition metal nanoparticles embedded within, or enveloped by, the substrate and the transition metal single-atom catalytic sites found on the surface of the substrate. The electronic interactions between the nanoparticle and the single-atom sites may include electrical cooperation, or electrically cooperative interations. In particular, it is believed that the transition metal nanoparticles that are embedded within the conductive carbon substrate, when in use as an electrocatalyst, regulates the electron density of the surface single-atom catalytic sites.

### Transition Metal

In the catalyst of the present invention, transition metals are found in two forms: as a single-atom catalytic site and as a nanoparticle. According to its plain meaning, a “single-atom catalytic site” refers to a single atom of a transition metal that is located on the surface of the catalyst substrate (which is distinct from a “single-atom catalyst”, which refers to a catalyst comprising solely single-atom catalyst sites on a substrate). Similarly, according to its plain meaning, a “nanoparticle” refers to a particle that is measured in the nanoscale, such as between about 1 nm and about 999 nm. Both the single-atom catalyst site and the nanoparticles are formed from, or comprise, or consist of, a transition metal. By “transition metal”, it is meant an element that can be found in the d-block of the periodic table, which can be found between groups 3 and 12 inclusive. Examples of suitable transition metals include, for instance, cobalt, iron, nickel, copper, zinc, chromium, manganese, yttrium, scandium, tin, bismuth, and molybdenum. In certain embodiments, the transition metal is not a precious metal. By “precious metal”, it is meant an element that is an investment or industrial commodity with an ISO4217 currency code, being gold, silver, platinum and palladium. By avoiding precious metals, the catalyst of the present invention can be produced in relatively large quantities on an industrial scale at relatively low cost. However, the inventors expect that precious metals such as gold, silver, platinum and palladium could still be effectively used in the catalyst of the present invention. In some preferred embodiments, the transition metal of the present invention is selected from cobalt, iron and nickel. The transition metal may preferably be nickel.

In order to operate effectively as a catalyst, it is expected that the catalyst comprises more than one, or a plurality of, single-atom catalytic sites. Each single-atom catalytic site may be formed from the same transition metal, or they may be different. In other words, the catalyst of the present invention may comprise a population of single-atom catalytic sites that are formed from the same transition metal (i.e., a homogenous population) or it may comprise a population of single-atom catalytic sites that are formed from two or more different transition metals (i.e., a heterogenous population). Each single-atom catalytic site may be formed from a transition metal selected from cobalt, nickel or iron.

The catalyst may comprise at least one, or a plurality of, transition metal nanoparticles. Each nanoparticle may be formed from or comprise one transition metal, or they may be formed from or comprise two or more different transition metals. In other words, a catalyst may comprise one transition metal, which is used to form both the single-atom catalytic sites and the nanoparticles, or it may comprise two or more transition metals. When two or more transition metals are used, the catalyst may be arranged in any suitable way, such as: a single transition metal may be used to form all of the single-atom catalytic sites, which is different from the single transition metal used to form all of the nanoparticles; or the single-atom catalytic sites are a heterogenous population with two or more transition metals present and the nanoparticles arc homogenously formed from a single transaction metal; or the single-atom catalytic sites are a homogenous population formed from a single transition metal and the nanoparticles are heterogenous with two or more transition metals present, either as a heterogenous distribution of pure nanoparticles of two or more different transition metals, or as alloyed nanoparticles, or as a mixture of both; or the catalyst may comprise any combination of the above arrangements. In one embodiment, the catalyst of the present invention comprises a single transition metal, with both the single-atom catalytic sites and the nanoparticles formed from the same transition metal.

In some embodiments of the present invention, each nanoparticle present in the catalysts of the present invention may have a diameter of between about 1 nm and about 300 nm, or between about 5 nm and about 200 nm, or between about 10 nm and about 100 nm, or they may each be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 35, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295 or 300 nm. When a catalyst of the present invention comprises more than one nanoparticle, or a plurality of nanoparticles, the nanoparticles may have an average diameter of between about 1 nm and about 300 nm, or between about 5 nm and about 200 nm, or between about 10 nm and about 100 nm, or they may each be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 35, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295 or 300 nm. In some preferred embodiments, the average diameter of a plurality of nanoparticles may be between about 10 nm and about 30 nm, or between about 5 nm and about 40 nm, or may be about 20 nm. In embodiments whereby a plurality of transition metal nanoparticles are present, all nanoparticles may be formed from the same transition metal, or a catalyst may comprise two or more different transition metals, either as pure metal nanoparticles (i.e., one transition metal per nanoparticle) or as alloys of more than one transition metal.

When a plurality of nanoparticles are present, it is expected that they would be present in a distribution range around the average diameter size. The size distribution of the plurality of nanoparticles may be relatively tightly distributed around the average size. For instance, 95% of the plurality of nanoparticles (i.e., the D₉₅ value) may be relatively tightly distributed so as to fall within about 5 nm, or about 10 nm, or about 15 nm of the average diameter. For instance, if the average size of the nanoparticles is 75 nm with a tight distribution, then 95% of the nanoparticles may be expected to be between about 70 and about 80 nm in diameter, or between about 65 nm and about 85 nm, or between about 60 nm and about 90 nm. Alternatively, the size distribution of the plurality of nanoparticles may be relatively broadly distributed around the average size. For instance, 95% of the plurality of nanoparticles (i.e., the D₉₅) may be relatively broadly distributed to fall within about 50 nm, or about 75 nm, or about 100 nm of the average diameter. For instance, if the average size of the nanoparticles is 75 nm with a broad distribution, then 95% of the nanoparticles may be expected to be between about 25 and about 125 nm in diameter, or up to about 150 nm, or up to about 200 nm. In some embodiments, the average diameter of a plurality of nanoparticles may be between about 10 nm and about 30 nm, or between about 5 nm and about 40 nm, or may be about 20 nm, with a tight distribution of about 5 nm, or 10 nm of range around the average diameter size.

### Substrate

Catalysts are generally formed from a substrate upon which catalytic sites are located. In the case of electrocatalysts, which participate in electrochemical reactions, the substrate is generally also conductive so that it also acts as an electrode (either the cathode or anode). In other words, in electrocatalysts generally, and the present invention specifically, the substrate of the catalyst acts as an electrode (i.e., an inert, conductive material) which supplies current to the catalytic sites located on the surface of the substrate.

In one embodiment of the present invention, the substrate comprises a conductive carbon substrate. The conductive carbon substrate must be capable of being arranged such that the nanoparticles are completely enveloped by, or embedded with, the substrate, so that the nanoparticles cannot access the surface of the catalyst or directly contribute to catalytic activity. The conductive carbon substrate may take any suitable form, such as carbon nanotubes, graphite sheets, buckyballs or any combination thereof, which provided fast electron and mass transfer, outperforming other support materials such as metals (Au, Cu), alloys (Pd₁₀Te₃), metal oxide (CeO₂, CuO, Al₂O₃), metal compounds (zinc-indium sulfide, In₂Se₃), and polymers (poly(4-vinylpyridine)). In one embodiment, the conductive carbon substrate is in the form of nanotubes, with transition metal nanoparticles disposed within the nanotubes. The conductive carbon substrate may be pure carbon, or it may comprise at least one dopant, whereby it is understood that a dopant is a trace impurity element (no specific definition of dopants, only a trace impurity introduced into the pure materials is called doping.) that is introduced to alter the electrical, optical or structural properties of the substrate. The dopants may be a non-metallic element, such as nitrogen, oxygen, sulfur, boron, phosphorous or silicon, or it may be a metallic or semi-metallic element, such as aluminium, gallium, arsenic, lithium, bismuth, gold or silver. The dopants may comprise a non-metallic element and a metallic element, or more than one a non-metallic element, or more than one metallic element. In a preferred embodiment, the dopant is nitrogen.

The single-atom catalytic sites of the present invention may directly interact with, or be bound to, the dopants in the carbon-based substrate. The transition metal single-atom sites may be bound to at least 1, or 2, 3, 4 or more, dopant elements. It is understood that the coordinate covalent bond(s) formed between the dopant elements and the single-atom transition metal may activate the metal so that it is catalytic, by withdrawing electron density from the valence shells of the transition metal single atom. In this regard, it is preferred that the dopant element used in the conductive carbon substrate is electron withdrawing, such as, for example, nitrogen, oxygen, sulfur or phosphorous. In one particularly suitable embodiment, it is understood that the interaction of three or four nitrogen dopant atoms with a single atom of nickel (i.e., Ni—N₄—C sites or Ni—N₃V-C sites, where V is vacancy) results in activation of the single nickel atom and alters its selectivity compared to bulk nickel metal.

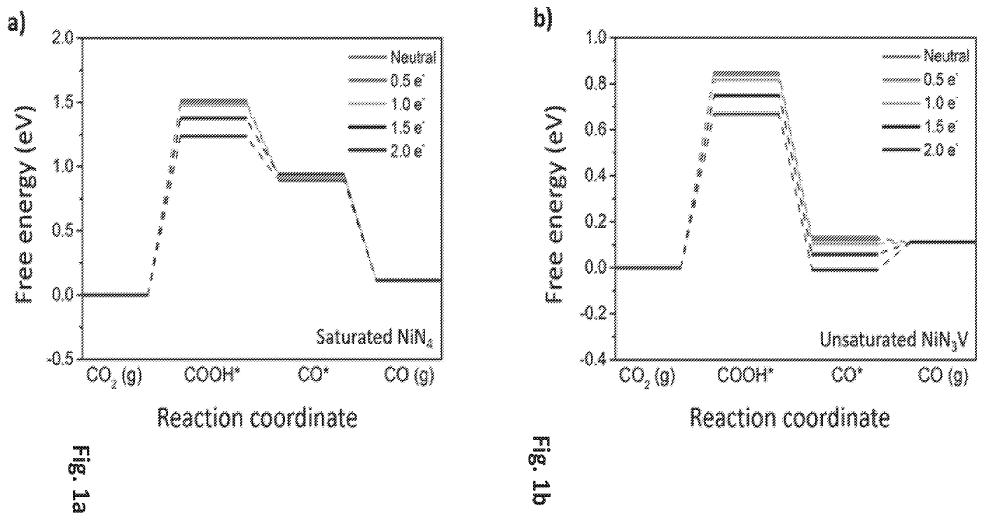

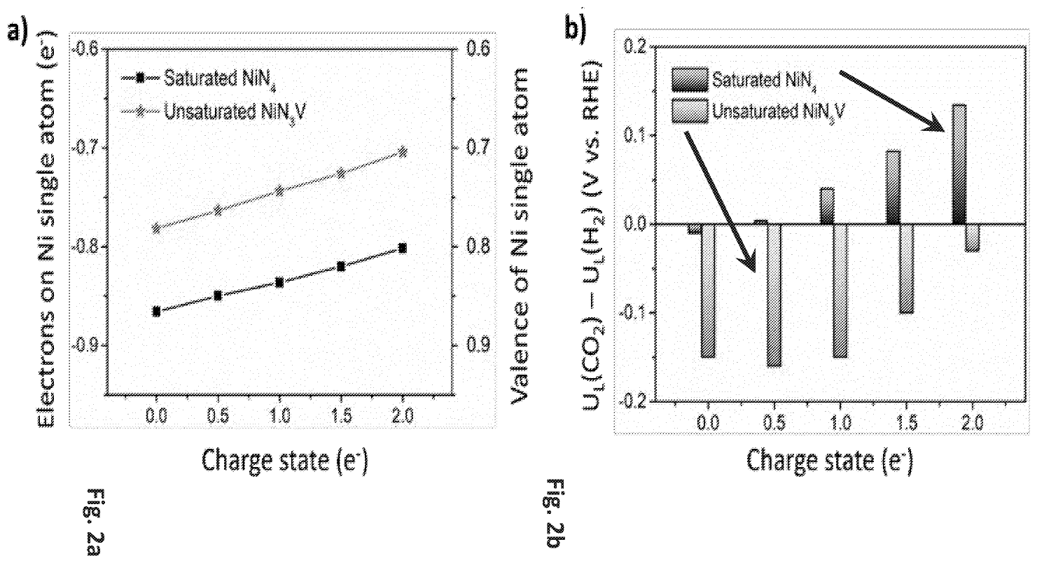

In this regard, as seen in FIG. 1, theoretical calculations using density functional theory shows that neutral (i.e., before application of a voltage) unsaturated Ni—N₃V-C sites have a lower free energy required to initiate the first step of the CO₂RR compared to saturated Ni—N₄—C sites, with the difference in overpotential required being 0.84 V for the unsaturated site, and 1.50 V for the saturated sites. After injecting extra electrons into the Ni—N—C structure (at between 0.5 and 2.0 e⁻), the binding strength of the intermediates (COOH* and CO*) on Ni—N₃V-C and Ni—N₄—C sites are significantly enhanced as demonstrated by the decrease in free energy. In comparison with the neutral cases, the stronger binding of COOH* on negatively charged Ni—N₄—C and Ni—N₃V-C decrease the overpotential of CO₂RR and enhance their activities.

To explain the effects of extra electrons on the enhanced binding strength of COOH* and CO* on Ni—Nₓ—C, the number of electrons on a Ni single atom was calculated, as shown in FIG. 2. The results show that the number of electrons on the Ni atom increases with the increase of the injected extra electrons on Ni—Nₓ—C. More electrons localized on a Ni single atom results in the stronger binding of COOH* and CO* compared to those in neutral cases.

Given that HER is a dominant side reaction that is competitive with CO₂RR, the difference between thermodynamic limiting potentials for CO₂RR and HER (denoted as U_{L}(CO₂)—U_{L}(H₂)) can be calculated, which can reflect the selectivity whereby a positive value shows selectivity for CO₂RR, and a negative value shows selectivity for HER. FIG. 2 also shows the U_{L}(CO₂)—U_{L}(H₂) on negatively charged Ni—N₄—C and Ni—N₃V-C sites, in comparison with the neutral cases (i.e., where the charge state is 0). Clearly, negatively charged Ni—N₄—C and Ni—N₃V-C sites both show more positive values of U_{L}(CO₂)—U_{L}(H₂) to the right of the graph, corresponding to their higher selectivity for CO production. Notably, the saturated Ni—N₄—C sites are most selective for the CO₂RR over the HER, albeit at a higher overpotential.

### Method of Production

The catalyst of the present invention is produced via a one-step solid-state pyrolysis method. The method may comprise obtaining a solid transition metal-containing compound, or more than one solid transition metal-containing compounds, depending on the transition metals that are desired for use in the catalyst.

The solid transition metal-containing compound may be a salt. It may be a hydrated salt or it may be an anhydrous salt. It may be any suitable salt, for example it may have an inorganic anion, such as a nitrate (NO₃⁻), phosphate (PO₄³⁻), sulfate (SO₄²⁻) or chloride (Cl⁻), or it may have an organic anion, such as a stearate, a palmate, a lactate, a gluconate, an acetate or a citrate. As the pyrolysis method is in the solid-state, the salt does not need to be water-soluble, as is the case with liquid-state methods. In one particular embodiment, the salt used is Ni(NO₃)₂.

The solid transition metal-containing compound(s) may be combined with a solid compound comprising carbon, which acts as a carbon source for forming the conductive carbon substrate. The carbon-containing compound may be any solid source of carbon. If a pure carbon substrate is required, the carbon-containing source may only comprise carbon and hydrogen atoms, such as polyethylene or polypropylene.

In some embodiments, as defined above, the substrate may include at least one dopant clement. The carbon-containing compound may comprise the dopant element such that the dopant element is introduced into the substrate as it is formed. For instance, the dopant element may be nitrogen. In such embodiments, the carbon-containing compound may comprise carbon, nitrogen and hydrogen, for example it may be melamine (C₃H₆N₆), urea (CO(NH₂)₂), cyanamide (CN₂H₂), polyaniline ([C₆H₅N]ₙ), and glucose monohydrate (C₆H₁₂O₆·H₂O). Alternatively, the dopant element may be added as a separate solid dopant-containing compound.

In a preferred embodiment of the present invention, the catalyst is formed from the solid-state pyrolysis of a transition metal salt and a compound containing carbon and nitrogen. In one such embodiment, the transition metal salt is a nickel salt, and the compound containing carbon and nitrogen is melamine. The nickel salt and the melamine are combined at room temperature. The nickel salt and melamine may be mixed in a mass ratio of between about 20:1 and about 1:20, or it may be between about 10:1 and about 1:10, or it may be between about 5:1 and about 1:5, or between about 20:1 and about 1:1, or it may be about 20:1, 19:1. 18:1, 17:1, 16:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20. The compounds may be combined in any suitable manner, such as stirring, mixing or grinding. The mixture is then heated to a temperature of between about 800° C. and about 1100° C., or between 900° C. and 1000° C., or between about 950° C. and 1050° C., or to a temperature of about 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1010° C., 1020° C., 1030° C., 1040° C., 1050° C., 1060° C., 1070° C., 1080° C., 1090° C., or 1100° C. In some embodiments, the mixture is heated to about 1000° C. The rate of heating may be constant, or it may vary. Each heating rate may be between about 1° C./minute and about 150° C./minute, or it may be between about 5° C./minute and about 100° C./minute, or it may be between about 10° C./minute and about 50° C./minute, or it may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 105, 110, 115, 120, 125, 130, 135, 140, 145, or 150° C./minute or any range therein. It is understood that during heating, when the mixture reaches about 500° C., or between about 400° C. and about 600° C., the melamine decomposes into carbon nitride. The heating may be held at about 500° C., or between about 400° C. and about 600° C., for a period of time to ensure that complete conversion of the melamine to carbon nitride, or there may be no pause in heating rate. Likewise, the heating may be held at a temperature of between about 800° C. and about 1100° C. to ensure complete carbonization. Each period of time may be up to about 6 hours, or it may be between 20 minutes and 5 hours, or it may be between 30 minutes and 3 hours, or it may be about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 minutes, or it may be about 1, 1.5, 2, 2.5, 3, 3.5, 4, 4.5, 5, 5.5 or 6 hours, or it may be any range therein. The heating may occur in the presence of inert gas. By “inert”, it is meant that the gas does not react, even during heating. The inert gas may be neon, argon, nitrogen, or another suitable inert gas, or a mixture thereof. The inert gas may be argon. The heating may occur in a sealed chamber. It may a pyrolysis reactor.

Once the melamine is fully decomposed, and with further heating, the nickel salts decompose into nickel nanoparticles and nickel single atoms. It is understood that the nanoparticles catalyse the production of nitrogen-doped carbon nanotubes around the nickel nanoparticles, whilst nickel single atoms are simultaneously trapped by the nitrogen-doped carbon nanotubes via thermal emitting. After carbonisation at about 1000° C., or between about 800° C. and about 1100° C., the catalyst of the present invention is obtained. The above conditions relate to nickel salts and melamine and are provided by way of example only; however, it is expected that the skilled person would be able to amend the conditions of the above method to suit any particular transition metal-containing compound and carbon-containing compound.

To fully characterise the activity of the catalyst of the present invention, a form of the catalyst may be made that consists of solely transition metal single-atom sites and substrate, and which is substantially or entirely devoid of nanoparticles. To produce a solely single atom-based catalyst, the method includes a further step of selectively dissolving the nanoparticles. Any suitable process can be used which dissolves the nanoparticles and maintains the covalently bound single atom sites, and several methods are known in the art. In one particular process, the catalyst is treated with ammonium chloride (NH₄Cl) so as to dissolve all, or substantially all, of the transition metal nanoparticles. The resultant catalyst, comprising only substrate and single-atom catalytic sites, may then be used in a carbon dioxide electrolysis process. However, as described in more detail below and particularly with reference to the examples, the inventors assert that superior catalytic activity and properties are provided by catalysts with a combination of single-atom catalytic sites and nanoparticles.

### Electrolyser

As discussed above, the catalyst described herein is intended for use as a CO₂RR selective electrocatalyst. It may be used in a method for the conversion of CO₂ to CO. The conversion may occur via the steps discussed above. Preferably, the main product of the method is CO with limited, if any, H₂ produced.

In particular, the catalyst as described herein is arranged as the cathode in an electrolysis cell, or an electrolyser. When in use, the cathode, which comprises the catalyst of the present invention, is provided a source of electrons from an energy source. It may be referred to as an electrocatalyst or an electrolysis catalyst. The skilled person would be familiar with the features of an electrolysis cell, which include at a minimum, a cathode, an anode, an electrolyte and an energy source, and that the reduction reaction occurs at the cathode and the oxidation reaction occurs at the anode. It is expected that the catalyst of the present invention may be able to be used in any suitable electrolyser or electrolysis cell or apparatus. The energy source may be any suitable source of energy that is capable of providing an electrical current at a useful voltage. The energy source may be adjustable, so that an optimal current and voltage are applied, or it may produce electricity at a fixed current and voltage. Preferably, the catalyst is capable of selectively converting CO₂ to CO, without generating hydrogen gas and operating at relatively high current (i.e., greater than 300 mA/cm²) and low voltage (i.e., less than −0.55 V).

The electrolysis cell may be arranged in any suitable manner known in the art. For instance, the electrolysis cell may be arranged as a H-cell, an alkaline flow cell, a membrane electrode assembly (MEA) or a zero-gap full cell, and a fuel cell, for example. Generally, the electrolysis cell is arranged so that the cathode (i.e., the working electrode) is in contact with the electrolyte, CO₂ and energy source, which is separated from the anode (i.e., the counter electrode) by an ion-exchange membrane.

The electrolyte of the electrolytic cell may be any suitable electrolyte, including acid, neutral, and alkaline. The electrolyte may be an ionic substance dissolved in water. The anionic substance may fully dissociate in water to provide anions and cations. Preferably, the electrolyte does not participate in side reactions that would produce impurities. Suitable electrolytes include, for example, KHCO₃, Na₂SO₄, NaCl, KOH, and KCl, and the mixture of acid and Li⁺/Na⁺/K⁺/Cs⁺ salts. In a preferred embodiment, the electrolyte comprises KHCO₃. The concentration of the ionic substance dissolved in the water may be between about 0.01 M and about 2 M, or it may be between about 0.05 M and about 0.75 M, or it may be between about 0.1 M and about 0.5 M, or it may be between about 0.5 M and 1.5 M, or it may be about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, or 1.5 M or it may be any range therein.

In the electrolyser, or electrolytic cell, as described herein, comprises an anode. Any suitable anode may be used, which does not degrade during use, and does not participate in any unsuitable side reactions. For example, the anode may comprise NiFe or IrO₂, or another suitable material such as Ti mesh and Ni foam.

The electrolyser, or the electrolysis cell, as described herein, may be used in a method to produce CO. The electrolyser may be provided CO₂ as a feed stream. The feed stream may entirely, or substantially, consist of CO₂, or it may comprise CO₂ with one or more other gas or gases present. The other gas or gases may be, for example, Ar, N₂, O₂, H₂O (as vapour), SO₂, NO₂, CH₄, H₂S, or any other gas, or any mixture thereof. The feed stream may be provided from another industrial process, such as a biomass processing plant, a coal fired power plant, or an oil refinery, whereby a stream of gas is produced as a by-product that comprises CO₂, or it may be captured from the atmosphere.

The electrolyser, or the electrolysis cell, as described herein, may operate at an applied voltage of between about −0.2 V and about −2.5 V, or between about −0.5 V and −1.25 V, or between about −0.8 V and about 1 V, or at about −0.2 V, −0.25 V, −0.3 V, −0.35 V, −0.4 V, −0.45 V, −0.5 V, −0.55 V, −0.6 V, −0.65 V, −0.7 V, −0.75 V, −0.8 V, −0.85 V, −0.9 V, −0.95 V, −1 V, −1.05 V, −1.1 V, −1.15 V, −1.2 V, −1.25 V, −1.3 V, −1.35 V, −1.4 V, −1.45 V, −1.5 V, 1.55 V, −1.6 V, −1.65 V, −1.7 V, −1.75 V, −1.8 V, −1.85 V, −1.9 V, −1.95 V, −2 V, −2.05 V, −2.1 V, −2.15 V, −2.2 V, −2.25 V, −2.3 V, −2.35 V, −2.4 V, −2.45 V and −2.5 V, or any range therein, whereby the voltage may be measured in comparison to a reversible hydrogen electrode (RHE) reference electrode. The electrolyser, or the electrolysis cell, may advantageously operate at relatively high current densities when supplied a voltage as described above. It is understood that the higher the current density, the faster the rate of CO production. For example, the cell may operate at a current density of greater than about 100 mA cm⁻², or greater than about 200 mA cm⁻², or greater than about 300 mA cm⁻², or greater than about 400 mA cm⁻², or greater than about 500 mA cm⁻², or greater than about 600 mA cm⁻², or any range therein. During operation, the catalyst (i.e., the cathode) may be stable for a period of time of continuous operation. By “stable”, it is meant that there is no significant degradation of the cathode material and no significant decrease in output or operating current density, whereby “significant” may refer to no more than about 5%, or no more than about 10%, or no more than about 15%, or no more than about 20%, of degradation during operation. The period of time that the cathode is stable may be greater than about 5 hours, or greater than about 10 hours, or greater than about 24 hours, or greater than about 30 hours, or greater than about 40 hours, or greater than about 50 hours, or any range therein.

It will be appreciated by persons of ordinary skill in the art that numerous variations and/or modifications can be made to the present invention as disclosed in the specific embodiments without departing from the spirit or scope of the present invention as broadly described. The following embodiments and examples are, therefore, to be considered in all respects as illustrative and not restrictive.

### EXAMPLES

The present invention will now be described with reference to specific examples, which should not be construed as in any way limiting.

As used below, “NiSA” refers to a catalyst comprising nickel single-atom (SA) catalytic sites and a conductive carbon substrate doped with nitrogen. Likewise, “NiSA/NP” refers to a catalyst as described herein, comprising nickel single-atom catalytic sites and nickel nanoparticles (NP) and a conductive carbon substrate doped with nitrogen.

### Example 1: Materials Synthesis and Characterization

NiSA/NP was prepared via a one-step solid-state pyrolysis as described above using Ni(NO₃)₂ and melamine mixture. Particularly, 0.3 g of Ni(NO₃)₂·6H₂O and 3 g of melamine were manually ground for 10 min to get the uniform light-green solid precursor. It was then annealed in the tube furnace in an Ar atmosphere at 1000° C. for 2 h with a heating rate of 5° C. min⁻¹. The final NiSA/NP catalyst can be obtained by washing the sintered powder with 3 M HCl and H₂O to remove the impurities.

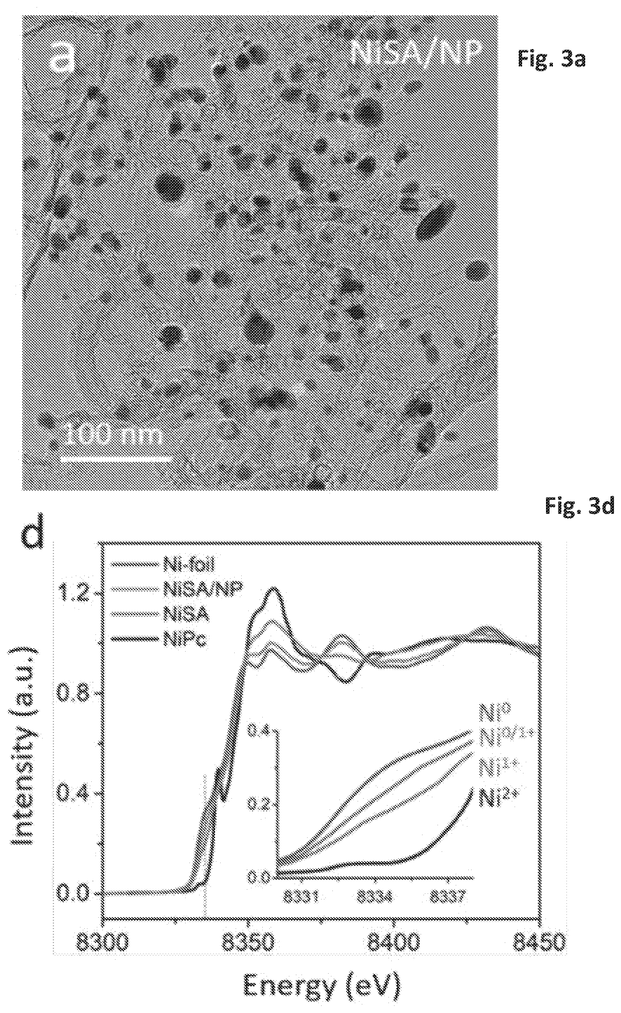

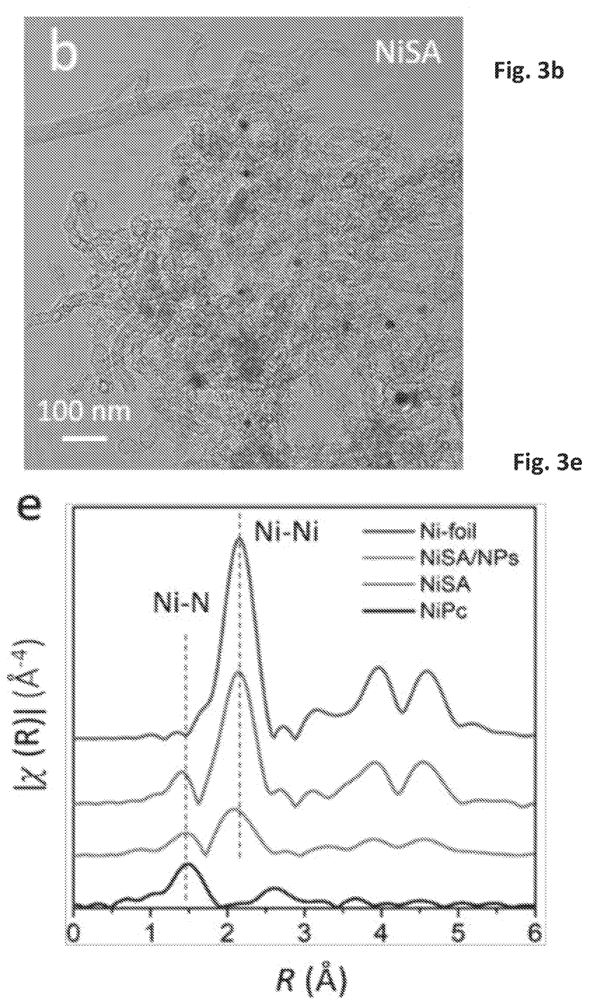

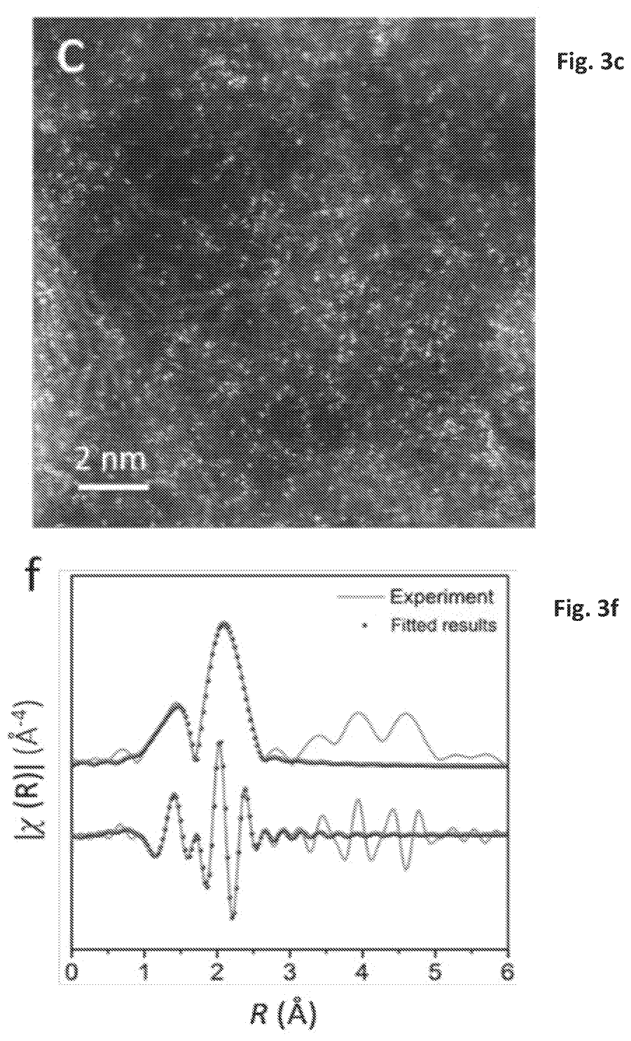

During heating, the melamine is first decomposed into carbon nitride at around 500° C. With the further increase of annealing temperature, the Ni nanoparticles will catalyze the carbon nitrite to generate the carbon nanotubes (CNTs) at the same time the Ni single atom will be trapped by the nitrogen doped CNTs via thermal emitting. After carbonization at 1000° C., the NiSA/NP can be obtained. FIG. 3a shows the morphology of the NiSA/NP catalysts, where the Ni nanoparticles (size of 10 to 30 nm) are confined inside of the nitrogen doped CNTs. The bright dots displayed in FIG. 3c are assigned to the Ni single atoms.

For comparison, the pure NiSA was prepared by the NH₄Cl treatment with NiSA/NP to remove the Ni nanoparticles inside of the CNTs. Namely, 0.1 g of NiSA/NP and 3 g of NH₄Cl were manually ground for 10 min to get the uniform black precursor. It was then annealed in the tube furnace in an Ar atmosphere at 1000° C. for 2 h with a heating rate of 5° C. min⁻¹. The final NiSA catalyst is obtained by washing the sintered powder with 3 M HCl at 80° C. and H₂O to remove the impurities.

Both the NiSA and NiSA/NP were characterized by a number of techniques. Scanning electron microscope (SEM) images were collected with a QUANTA 450. Transmission electron microscopy (TEM), high-resolution TEM (HRTEM), high angle annular dark-field scanning TEM (HAADF-STEM) were carried out on JEOL JEM-ARM200f microscope at 200 kV. XRD was performed on a PANalytical X'Pert X-ray diffraction system (45 kV, 40 mA, Cu Kα radiation). XPS results were recorded by Thermo ESCALAB250Xi. XAFS spectra at the Ni K-edge were collected in Australia Synchrotron center in a fluorescence mode.

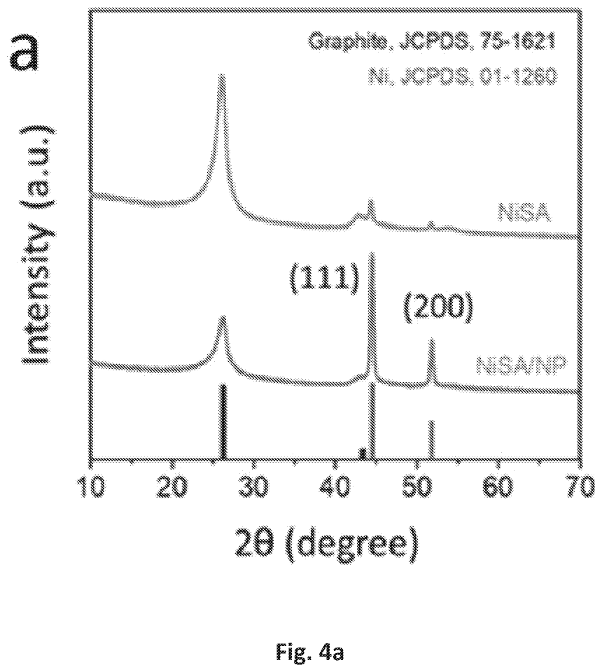

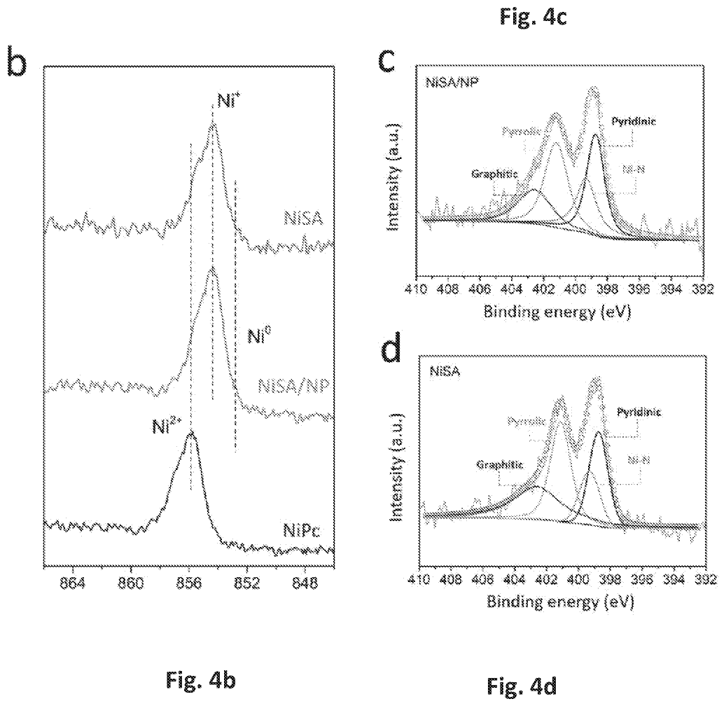

As confirmed by TEM (FIG. 3b) and X-ray diffraction (XRD) (FIG. 4a), most of the Ni nanoparticles inside of CNTs were removed after the treatment and Ni single atoms were saved. XRD also shows a main Ni(111) peak of the catalysts. No obvious metallic Ni⁰ signal for NiSA/NP can be observed in X-ray photoelectron spectroscopy (XPS) Ni 2p spectra (FIG. 4b), and this is because of the fully confined Ni nanoparticles inside of CNTs. The XPS N 1s spectra of NiSA and NiSA/NP exhibits similar pyridinic (398.5 eV), pyrrolic (401.2 eV), graphitic (402.7 eV), and Ni—N (399.4 eV) peaks (FIG. 4c, d), indicative of the same Ni—N—C structure after the removal of Ni nanoparticles. According to the ICP-OES, the Ni contents in NiSA/NP and NiSA are 8.8 wt % and 4.6 wt %, respectively. The high content of Ni single atom can be attributed to (i) the in-situ formation of Ni—N—C during the growth of CNTs and (ii) the excessive Ni sources provide by the Ni nanoparticles.

The Ni K edge X-ray absorption near-edge structure (XANES) and extended X-ray absorption fine structure (EXAFS) measurements were carried out to identify the electronic structure and coordination environment of catalysts. Ni foil and NiPc were used as references for metallic Ni and Ni²⁺, respectively. The near-edge positions of NiSA sites between Ni foil and NiPc (FIG. 3d), corresponding to a valence state of Ni¹⁺, which is also confirmed by the XPS analysis (FIG. 4c, d). Ni¹⁺—N—C has been revealed as a highly active site for CO₂-to-CO conversion. Most importantly, the near edge position of NiSA/NP is between the Ni foil ad NiSA, corresponding to an even lower valence state than Ni¹⁺. The Fourier-transformed k³-weighted spectra of the samples exhibit two major peaks at 1.45 Å and 2.1 Å, which is assigned to Ni—N and Ni—Ni coordination shells, respectively (FIG. 3e). The significantly decreased Ni—Ni peak density in NiSA compared with NiSA/NP corresponds to the removal of Ni nanoparticles. Note that the Ni—Ni peak is easy to be observed even there is only a small amount of Ni NPs residual in the catalysts. Based on the fitting of Ni—N shell on NiSA, the coordination number is 2.7 which is close to the coordinative unsaturated Ni—N₃-C structure (FIG. 3f).

### Example 2: Electrochemical CO₂ Conversion

The electrochemical testing was first conducted in an H-cell using 0.5 M KHCO₃ electrolyte. CO₂ electrolysis in H-cells was performed in a gas-tight H-cell with two-compartments separated by a cation exchange membrane (Nafion®117). A Pt plate was used as the counter electrode, a saturated calomel electrode (SCE) was used as the reference electrode, and CO₂-saturated 0.5 M KHCO₃ was used as the electrolyte, respectively. To prepare the working electrodes, 10 mg of catalyst and 100 μL of 5% Nafion solution were introduced into 100 μL of water and 300 μL of ethanol solution, and sonicated for 1 h. A 6.25 μL of the catalyst ink was coated onto a carbon fiber paper substrate and dried in air, giving an effective area of 0.25 cm⁻² with catalyst loading of 0.5 mg cm⁻². In H-cells, LSV and potentiostatic data were corrected with an iR compensation of 80%.

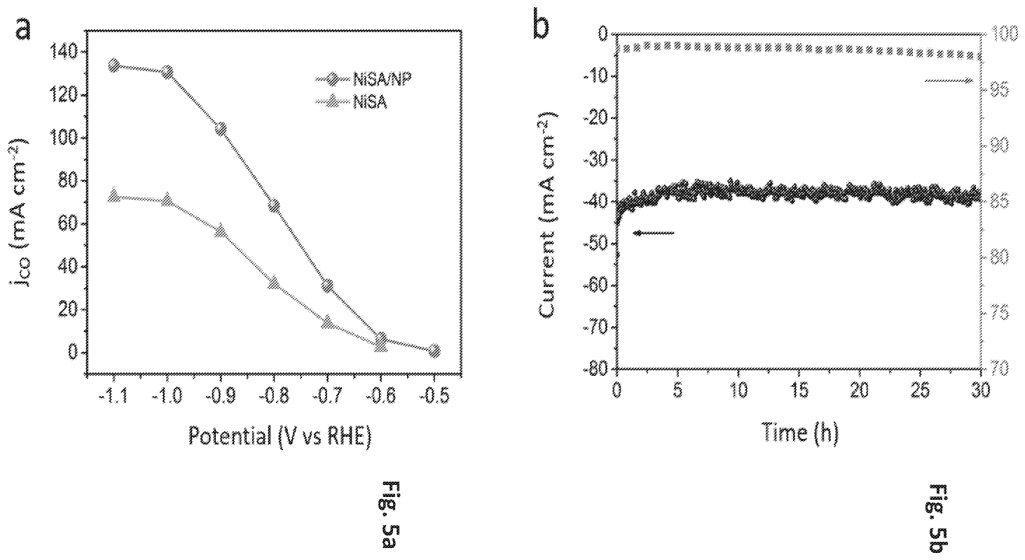

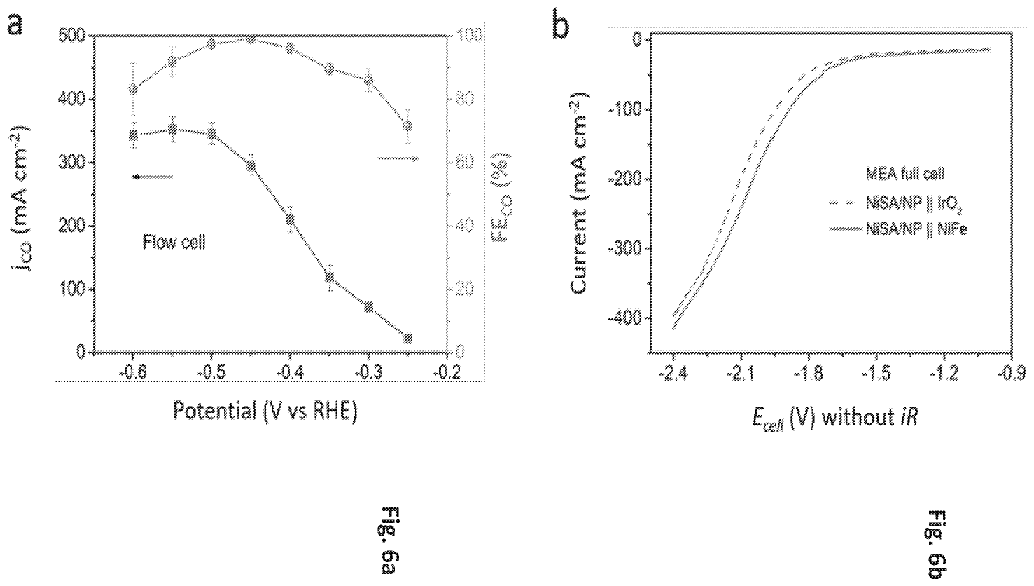

FIG. 5a displays the partial CO currents at different potentials, where the NiSA/NP outperforms the NiSA in a wide potential window, achieving a high current of 131 mA cm⁻² at −1.0 V vs RHE which is almost doubled compared with NiSA. To the best knowledge of the inventors, this is the highest current ever achieved compared with the other CO₂-to-CO catalysts in the H cell. The corresponding Faradic efficiency of CO (FE_{CO}) for NiSA/NP can achieve a FE_{CO} above 99% at −0.8 V. Besides, the onsite potential of NiSA/NP is at around −0.5 V vs RHE, which corresponds to theoretical models of the Ni—N₃V-C arrangement. The electrochemically active surface area (ECSA) is evaluated from double-layer capacitance (C_{dl}) to elucidate the origin of the enhanced catalytic activity on NiSA/NP. The NiSA/NP shows slightly higher C_{dl} compared with NiSA (1.4 mF vs 1.2 mF), suggesting that the improved catalytic activity is primarily attributed to the intrinsic reactivity of each site, rather than a surface area effect. Stability testing is then performed at −0.75 V vs RHE, NiSA/NP shows robust durability for CO₂RR during 30 hours of continuous electrolysis, maintaining 99% of the initial FE for CO production with current density almost remain constant (FIG. 5b). This can be attributed to the strong immobilization and close proximity between catalysts and CNTs, which reduces aggregation and bypasses undesired side reactions to suppress catalyst deactivation.

To assess the performance of catalysts at industrial-relevant conditions, we further evaluate the CO₂RR based on gas diffusion electrode devices. The windows for electrolysis were set to 1 cm×1 cm. Each chamber has an inlet and an outlet for electrolyte, and an Ag/AgCl reference electrode was placed in the catholyte chamber. The catalyst ink was prepared by mixing 10 mg of catalyst, 3 mL of ethanol and 100 μL of a Nafion perfluorinated resin solution. Then, catalysts were air-brushed onto 3×3 cm⁻² 38 BC gas diffusion layer (FuelCellStore) electrodes, and used as the cathode. Commercial IrO₂ sprayed on Titanium mesh was used as a counter electrode for oxygen evolution reaction (OER). An anion exchange membrane (FAA-3-50, FuelCellStore) was used to separate the cathode and anode chambers. 1 M KOH solution was used as the electrolytes. The catholyte and anolyte were cycled at a flow rate of 10 mL min⁻¹ by using a peristaltic pump. LSV and potentiostatic data were corrected with an iR compensation of 80%.

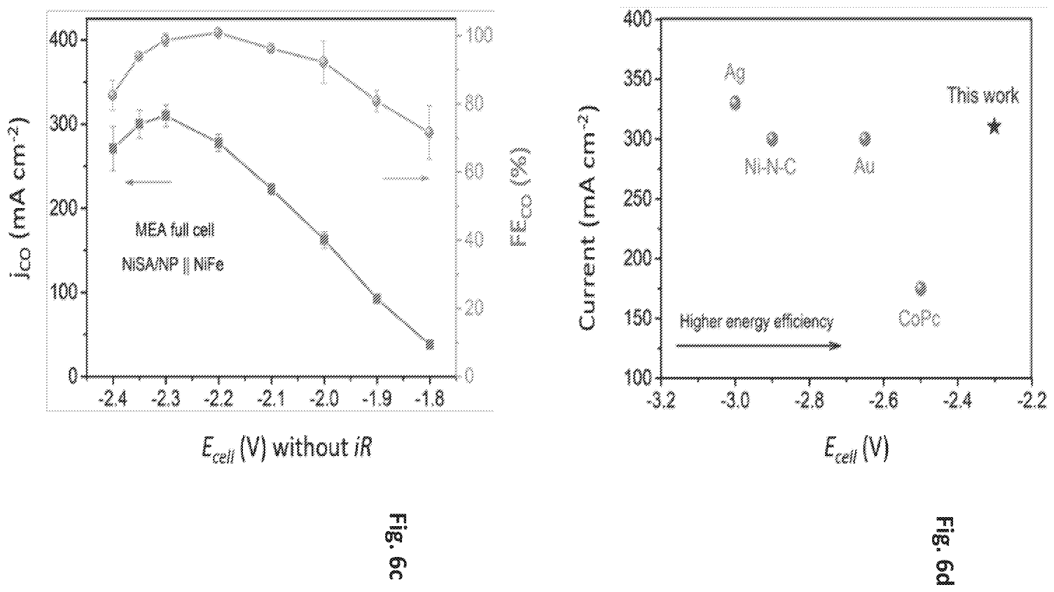

FIG. 6a displays the CO FEs and partial current densities plotted against the iR-corrected potentials in 1 M KOH microfluidic cells. The NiSA/NP shows a low onsite potential at around −0.25 V. Then, the CO partial currents quickly increase to above 200 mA cm⁻² at −0.4 V with FE_{CO} of 96% and reaches 346 mA cm⁻² at −0.5 V with FE_{CO} of 98%. As a comparison, the highest current on NiSA is 263 mA cm⁻² at −0.65 V. The superior CO₂RR performance of NiSA/NP in flow cell can be attributed to (i) the significantly enhanced CO₂ mass transport based on gas diffusion electrode and (ii) the catalytic promotion effect in alkaline electrolyte.

The zero-gap MEA device, which is a fuel-cell-like setup, is generally considered to be a more promising prototype for practical application because of the very low cell resistance and robust structure. The windows for electrolysis were set to 1 cm⁻². Cathode and anode chamber have an inlet and an outlet for gas and electrolyte, respectively. Both the cathode and anode catalyst ink were prepared by mixing 10 mg of catalyst, 3 mL of ethanol and 100 μL of a Nafion perfluorinated resin solution. Then, the cathode catalyst was air-brushed onto 3×3 cm⁻² 38 BC gas diffusion layer (FuelCellStore) electrodes, and the anode catalyst was air-brushed onto 3×3 cm⁻² 35 AA carbon paper (Ion Power) electrodes. The anode NiFe catalysts were prepared by a previously reported method. An Sustainion® X37-50 was used to as the membrane. The cathode was feed with humidified CO₂ gas and the anode was feed with 1 M KOH electrolytes. The applied cell voltages were recorded without iR correction.

FIG. 6b exhibits the LSV curves of two different full cells with IrO₂ and NiFe anodes, respectively. With 1 M KOH as the anode electrolyte, the NiSA/NP∥NiFe can show even better performance compared with widely used IrO₂ anode. It is worth noting that the Ir-based anode can cost more than 60% of the total price of MEA device, so that the development of the low-cost substitution is highly desirable. As shown in FIG. 6c, NiSA/NP∥NiFe delivers a j_{CO} of 163 mA cm⁻² with FE_{CO} of 92% at −2.0 V without iR compensation. With further increase of cell voltage to −2.3 V, the j_{CO} can reach up to 310 mA cm⁻² with FE_{CO} of ˜99%. The corresponding full cell energy efficiency (EE) is 57% based on the equation: EE=ΔE⁰/ΔE^{Applied}×FE_{CO}, where ΔE⁰ is the equilibrium full cell voltage (E⁰_{CO}−E⁰_{OER}=−0.11 V−1.23 V=−1.34 V), and ΔE^{Applied} is the applied full cell voltage without iR-correction. By way of comparison, certain Ag-based MEA device can achieve current densities above 600 mA cm⁻² at a high cell voltage of 3.5 V (EE=˜35%). Take the EE into consideration, NiSA/NP∥NiFe shows the lowest cell voltage for CO production at ˜300 mA cm⁻² ever reported (FIG. 6d).

1. A catalyst comprising:
a conductive carbon substrate comprising nitrogen;
a transition metal nanoparticle enveloped within the conductive carbon substrate; and
a single atom transition metal catalytic site located on a surface of the conductive carbon substrate,
wherein the transition metal nanoparticle and the single atom transition metal catalytic site are arranged so that there is electrical communication between the single atom transition metal catalytic site and the transition metal nanoparticle.

2. The catalyst of claim 1, wherein the transition metal nanoparticle comprises cobalt, nickel, iron or a combination thereof.

3. The catalyst of claim 1 or claim 2, wherein the single atom transition metal catalytic site comprises cobalt, nickel, iron or a combination thereof.

4. The catalyst of any one of claims 1 to 3, wherein the conductive carbon substrate is a carbon nanotube.

5. The catalyst of any one of claims 1 to 4, wherein when two or more transition metal nanoparticles are present, the transition metal nanoparticles have an average diameter of between about 10 and about 30 nm.

6. The catalyst of any one of claims 1 to 5, wherein the catalyst is an electrocatalyst.

7. The catalyst of claim 6, wherein the electrocatalyst is for use in carbon dioxide electrocatalysis.

8. A method of producing a catalyst comprising a conductive carbon substrate doped with nitrogen, a transition metal nanoparticle enveloped within the conductive carbon substrate, and a single atom transition metal catalytic site, said method comprising the following steps:
heating a mixture to a temperature between about 800° C. and about 1100° C., the mixture comprising:
a transition metal salt; and
a compound comprising carbon and nitrogen,
under such conditions to thereby produce the catalyst.

9. The method of claim 8, wherein the transition metal salt comprises cobalt, nickel, iron or a combination thereof.

10. The method of claim 9, wherein the transition metal salt is selected from the group consisting of Ni(NO₃)₂, NiSO₄ and NiCl₂.

11. The method of claim 10, wherein the compound is selected from the group consisting of melamine (C₃H₆N₆), urea (CO(NH₂)₂) and cyanamide (CN₂H₂).

12. The method of claim 11, wherein the temperature is about 1000° C.

13. The method of any one of claims 8 to 12, wherein the conditions comprise heating the mixture with an inert gas.

14. The method of claim 13, wherein the inert gas is selected from neon, argon, nitrogen or a mixture thereof.

15. A catalyst produced by the method of any one of claims 8 to 14.

16. Use of a catalyst according to any one of claim 1 to 7 or 15 as an electrolysis catalyst.

17. The use of claim 16, wherein the electrolysis catalyst converts carbon dioxide into carbon monoxide.

18. An electrolyser for producing carbon monoxide (CO) from carbon dioxide (CO₂), the electrolyser comprising a cathode which comprises a catalyst according to any one of claim 1 to 8 or 14.

19. A method of synthesising carbon monoxide (CO) comprising providing carbon dioxide (CO₂) to an electrolyser according to claim 18, wherein a voltage of between −0.2 V and −2.5 V is applied to the electrolyser to thereby provide said carbon monoxide (CO).
